(19) United States
(12) Patent Application Publication
(10) Pub. No.: US 2025/0073970 A1
(43) Pub. Date: Mar. 6, 2025

(54) CELL DEVICE

(71) Applicant: SEIKO EPSON CORPORATION, Tokyo (JP)

(72) Inventor: Taishi MATSUO, SHIOJIRI-SHI (JP)

(21) Appl. No.: 18/818,639

(22) Filed: Aug. 29, 2024

(30) Foreign Application Priority Data
Aug. 30, 2023 (JP) 2023-140247

(51) Int. Cl. B29C 45/17; B25J 9/00; B29C 45/82; B29C 45/84

(52) U.S. Cl. CPC B29C 45/1761; B25J 9/0009; B29C 45/1756; B29C 45/1769; B29C 45/82; B29C 45/84; B29C 2045/822; B29C 2945/76545; B29C 2945/76785; B29C 2945/76899

(57) ABSTRACT

A cell device includes a housing including an accommodation space and a door connected to the accommodation space, a movable device arranged in the accommodation space, and an operation section arranged in the accommodation space and configured to operate the movable device, wherein the door includes a light blocking section having a light blocking property and a light transmitting section having light transmissivity and in a state where the door is closed, the light blocking section overlaps with the operation section when the housing is viewed from a door side along a normal direction of the door. The operation section is arranged in the accommodation space so as to face the door and is arranged further to the door side than is the movable device.

### CROSS-REFERENCE TO RELATED APPLICATIONS

The present application is based on, and claims priority from JP Application Serial Number 2023-140247, filed Aug. 30, 2023, the disclosure of which is hereby incorporated by reference herein in its entirety.

### BACKGROUND OF THE INVENTION

### 1. Technical Field

The present disclosure relates to a cell device.

### 2. Related Art

JP-A-2016-083823 discloses an injection molding system including an injection molding machine and a robot. In such an injection molding system, an injection molding machine cover surrounding an operation range of a robot is provided, and when the injection molding machine cover is opened, operations of the robot and the injection molding machine are stopped. This ensures the safety of the injection molding system.

Although the arrangement of an operation section for operating the robot in JP-A-2016-083823 is not particularly described, if the operation section is arranged outside the injection molding machine, a user may erroneously operate the operation section during an operation of the injection molding system.

### SUMMARY OF THE INVENTION

A cell device of the present disclosure includes a housing including an accommodation space and a door connected to the accommodation space; a movable device arranged in the accommodation space; and an operation section arranged in the accommodation space and configured to operate the movable device, wherein the door includes a light blocking section having a light blocking property and a light transmitting section having light transmissivity and in a state where the door is closed, the light blocking section overlaps with the operation section when the housing is viewed from a door side along a normal direction of the door.

### BRIEF DESCRIPTION OF DRAWINGS

FIG. 1 is a front view showing a cell device according to a preferred embodiment.

FIG. 2 is a front view showing the cell device with the door opened.

FIG. 3 is a cross-sectional view showing the inside of a placement base.

FIG. 4 is a top view of the placement base.

FIG. 5 is a front view of the placement base.

FIG. 6 is a top view of the cell device.

FIG. 7 is a cross-sectional view of a hand.

FIG. 8 is a cross-sectional view of the hand.

### DETAILED DESCRIPTION OF THE INVENTION

Hereinafter, a cell device of the present disclosure will be described in detail based on a preferred embodiment shown in the accompanying drawings.

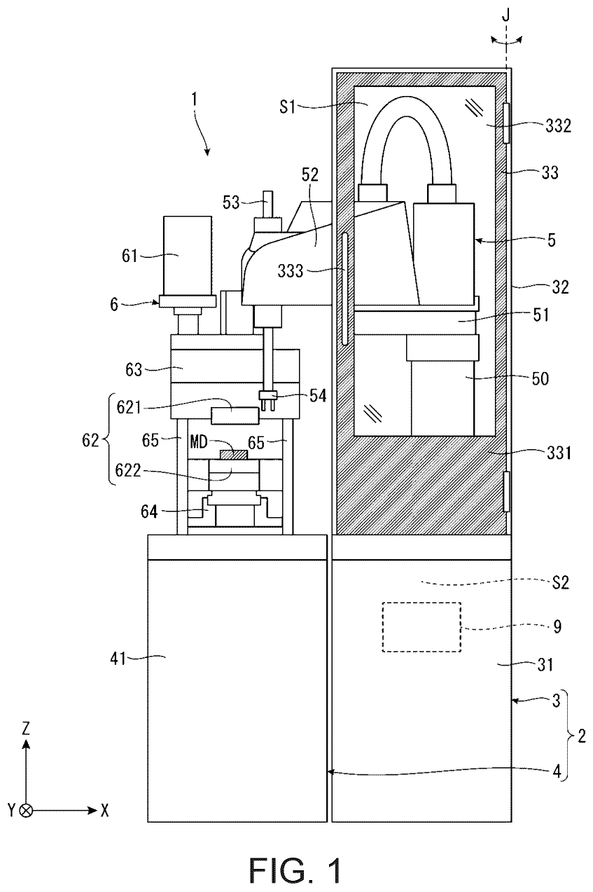

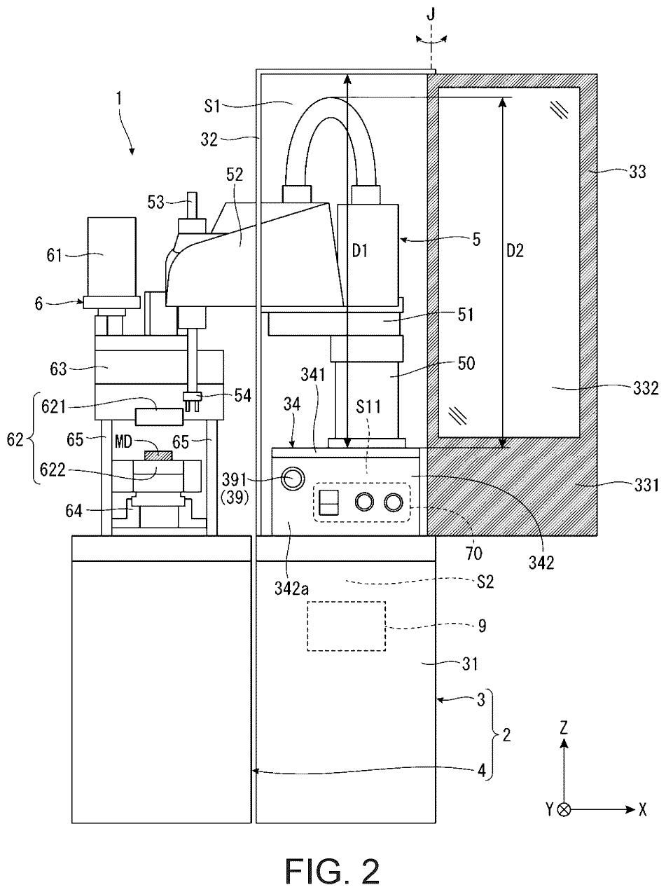

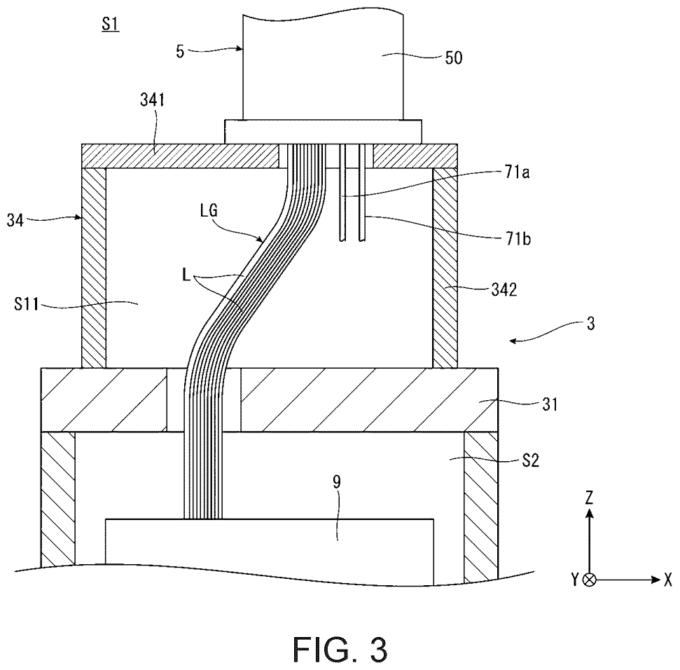

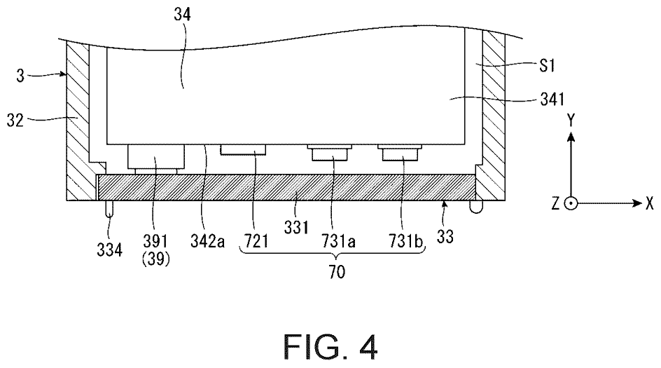

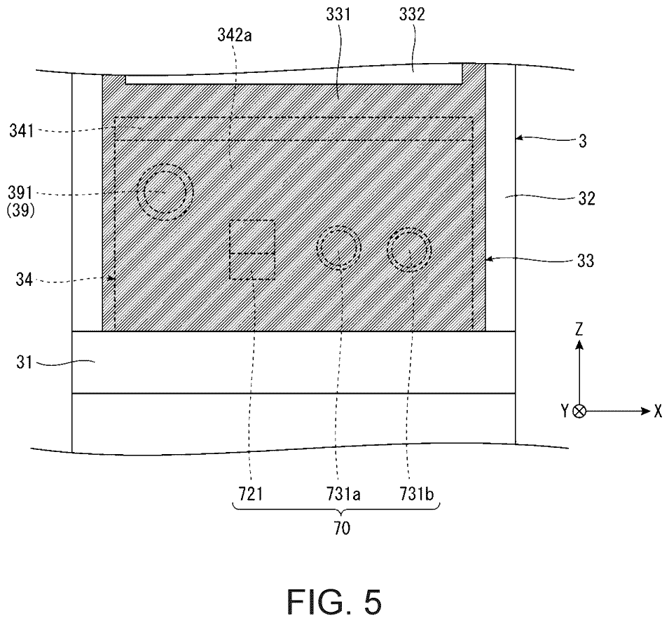

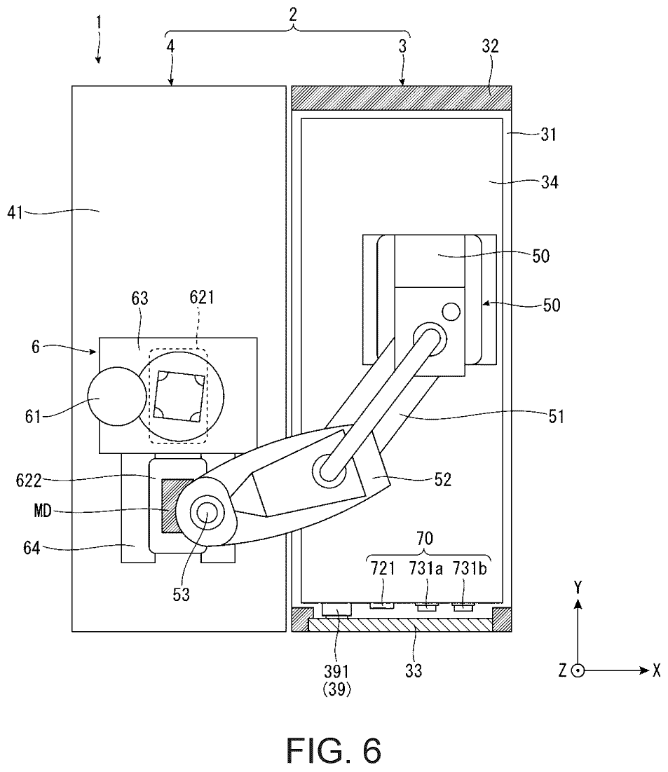

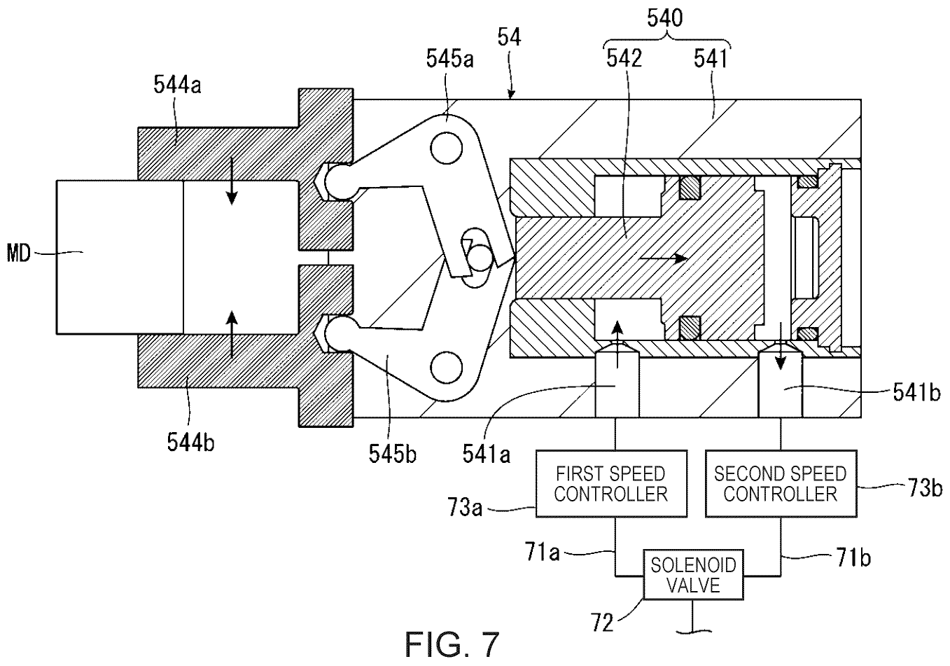

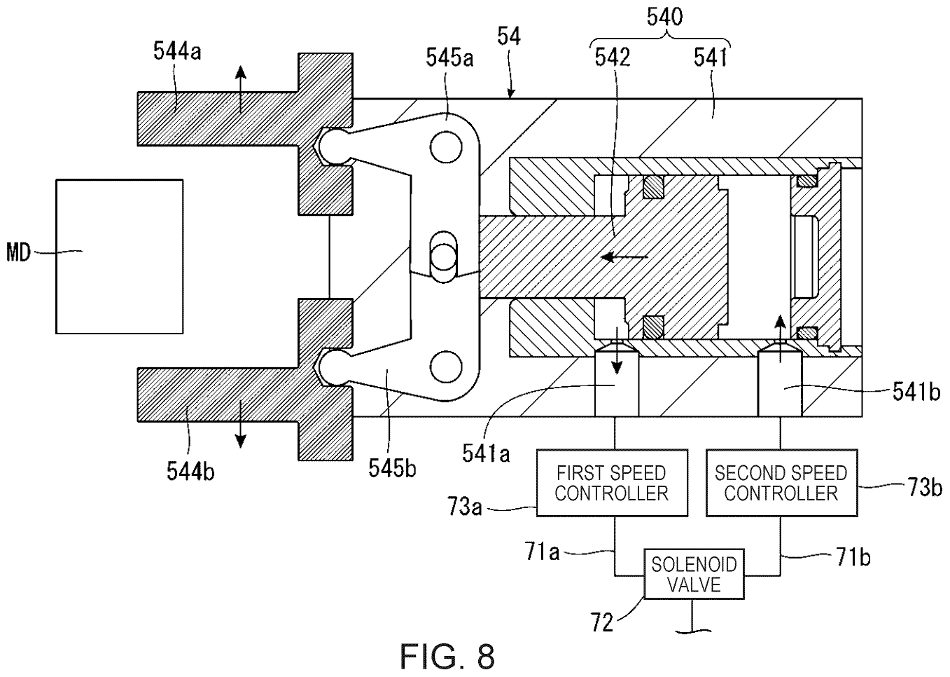

FIG. 1 is a front view showing a cell device according to a preferred embodiment. FIG. 2 is a front view showing the cell device with the door opened. FIG. 3 is a cross-sectional view showing the inside of a placement base. FIG. 4 is a top view of the placement base. FIG. 5 is a front view of the placement base. FIG. 6 is a top view of the cell device. FIGS. 7 and 8 are cross-sectional views of a hand.

In each of the drawings except for FIGS. 7 and 8, an X-axis, a Y-axis, and a Z-axis, which are three axes orthogonal to each other, are shown. Hereinafter, a direction along the X-axis is also referred to as an X-axis direction, a direction along the Y-axis is also referred to as a Y-axis direction, and a direction along the Z-axis is also referred to as a Z-axis direction. An arrow side of each axis is also referred to as a “plus side”, and a side opposite to an arrow is also referred to as a “minus side”. A plus side in the Z-axis direction is also referred to as “upper” and a minus side is referred to as “lower”.

A cell device 1 shown in FIG. 1 includes a housing 2, a robot 5 and an injection molding machine 6 as movable devices installed in the housing 2, and a control device 9 that controls driving of the robot 5 and the injection molding machine 6.

### Housing 2

As shown in FIG. 1, the housing 2 includes a first housing unit 3, a second housing unit 4 connected to the first housing unit 3 on a minus side in the X-axis direction. The second housing unit 4 can be attached to and detached from the first housing unit 3, and is connected to the first housing unit 3 using various metal fittings such as bolts. Although not shown, the housing 2 is provided with wheels and a stopper, and the cell device 1 can be moved to an arbitrary installation place using the wheels and can be fixed to that place using the stopper.

As shown in FIG. 1, the first housing unit 3 includes a base section 31, a cover member 32 arranged on an upper side of the base section 31, a first accommodation space S1 defined by the cover member 32, and a door 33 attached to the cover member 32 so as to be openable and closable. The robot 5 is accommodated in the first accommodation space S1. In the present embodiment, side walls positioned on both sides of the cover member 32 in the X-axis direction are removed for the convenience of an operation of the robot 5, but the present disclosure is not limited to this, and at least one side in the X-axis direction may be closed with a side wall according to an operation of the robot 5. The first housing unit 3 is provided with a sensor (not shown) for detecting opening and closing of the door 33. When the door 33 is opened during an operation of the cell device 1, the cell device 1 is urgently stopped for safety.

The base section 31 includes a second accommodation space S2 formed inside. Therefore, the second accommodation space S2 is positioned below the first accommodation space S1. The control device 9 is accommodated in the second accommodation space S2.

The door 33 is arranged on a front surface of the cover member 32 and is connected to the first accommodation space S1. Therefore, a user can access the first accommodation space S1 by opening the door 33. The door 33 is a single door that opens outwardly. An opening and closing axis J of door 33 is provided at an end section of a plus side in the X-axis direction. The door 33 includes a frame-shaped frame 331 as a light blocking section, a window section 332 as a light transmitting section attached to the inside of the frame 331, and a handle 333 attached to the frame 331. The handle 333 is attached to an end section on a minus side in the X-axis direction which is opposite to the opening and closing axis J. Thus, the door 33 can be opened and closed with a smaller force.

The frame 331 has a light blocking property. Therefore, in a state where the door 33 is closed, a portion of the first accommodation space S1 that needs to be can be hidden by the frame 331. In other words, it can be made invisible to a user. On the other hand, the window section 332 has light transmissivity. Therefore, even in a state where the door 33 is closed, the inside of the first accommodation space S1, particularly, the robot 5 can be visually observed through the window section 332. Therefore, the state of the robot 5 can be monitored during an operation of the cell device 1. For example, the frame 331 is made of various metal materials such as aluminum and stainless steel, and the window section 332 is made of light transmitting materials such as transparent glass and transparent plastic.

As shown in FIG. 2, the first housing unit 3 is arranged in the first accommodation space S1, and includes a placement base 34 for supporting the robot 5. The placement base 34 includes a placement section 341 arranged so as to be spaced apart from an upper surface of the base section 31 and a frame-shaped side wall 342 surrounding four sides of a space S11 formed between the placement section 341 and the base section 31. The robot 5 is supported on the placement section 341. Further, as shown in FIG. 3, a wiring group LG including at least one wiring L for electrically connecting the robot 5 and the control device 9 is accommodated in the space S11 in the placement base 34. In this way, by accommodating the wiring group LG in the placement base 34, it is possible to route the wiring group LG while avoiding a work area of the robot 5 above the placement base 34. Therefore, the wiring group LG is less likely to be exposed in a work area of the robot 5, and the possibility that the wiring group LG interferes with the robot 5 is reduced. Therefore, stable operation of the cell device 1 is realized. In particular, in the present embodiment, since the side wall 342 surrounds the entire circumference of the space S11, the wiring L is less likely to protrude to the outside of the placement base 34, and the above-described effect becomes more remarkable. However, the present disclosure is not limited thereto, and a portion of the side wall 342 may be removed, and a portion of the space S11 may be opened to the outside from that portion.

As shown in FIG. 2, the first housing unit 3 further includes an interlock device 39, which is a safety device for restricting opening and closing of the door 33. The interlock device 39 is arranged on a front surface section 342a of the side wall 342 of the placement base 34, that is, a portion of the side wall 342 facing the door 33. According to such an arrangement, since the interlock device 39 can be arranged outside a work area of the robot 5, the possibility that the interlock device 39 interferes with the robot 5 is reduced. It is also possible to secure a larger work area of the robot 5.

The interlock device 39 includes an electromagnet 391. When the electric current flowing through the electromagnet 391 is increased with the door 33 closed, the door 33 is firmly attracted to the electromagnet 391, and the door 33 is locked. In this state, the door 33 cannot be opened. On the other hand, when the electric current flowing through the electromagnet 391 is reduced or the energization of the electromagnet 391 is stopped, the door 33 is unlocked and can be opened. In the cell device 1, the door 33 is locked while the cell device 1 is operating normally, and the lock of the door 33 is released when the door 33 needs to be opened, for example, when the cell device 1 is stopped normally or when the cell device 1 is stopped urgently due to occurrence of an abnormality. This makes it possible to enhance the safety of the cell device 1. However, the configuration of the interlock device 39, the timing of unlocking, and the like are not particularly limited.

The interlock device 39 is desirably arranged in the vicinity of the handle 333. Therefore, in the present embodiment, the interlock device 39 is arranged at an end section of the front surface section 342a on a minus side in the X-axis direction. As a result, when the door 33 is opened, the stress applied to the door 33 due to attraction force of the electromagnet 391 can be suppressed, and damage or deformation of the door 33 can be effectively suppressed. However, the arrangement of the interlock device 39 is not particularly limited.

Here, the description will return to the door 33. As described above, the door 33 includes the frame-shaped frame 331. As shown in FIGS. 4 and 5, the frame 331 is arranged so as to overlap the placement base 34 when the cell device 1 is viewed from a front surface side (a door 33 side) in a state where the door 33 is closed. That is, the front surface section 342a of the placement base 34 and the frame 331 face each other. With the door 33 closed, the inner surface of the frame 331 is in contact with the electromagnet 391. Therefore, as described above, by configuring the frame 331 of a metal material, in particular a magnetic material, it is possible to lock the door 33 more reliably and firmly.

Furthermore, since the frame 331 has a light blocking property, in a state in which the door 33 is closed, the front surface section 342a is hidden by the door 33. Therefore, by arranging the interlock device 39 on the front surface section 342a, which is a portion to be hidden, the interlock device 39 can be hidden from a user during operation of the cell device 1. The interlock device 39 is a device that is not used by a user except for inspection, maintenance, and the like, that is, during normal operation. Therefore, by using the door 33 to hide the interlock device 39, unnecessary information that enters a user's field of view can be reduced. As a result, the user can perform work using the cell device 1 more intensively.

In particular, in the present embodiment, when the cell device 1 is viewed from the front surface side (a door 33 side) in a state where the door 33 is closed, the frame 331 is arranged so as to overlap the entire region of the side wall 342. Therefore, since the interlock device 39 is hidden by the frame 331 wherever the interlock device 39 is arranged within the front surface section 342a, the design flexibility of the arrangement of the interlock device 39 increases. However, this is not a limitation, and at least a part of the side wall 342 may not overlap the frame 331 and may be visible through the window section 332.

The first housing unit 3 has been described above. Next, the second housing unit 4 will be described. As shown in FIG. 1, the second housing unit 4 includes a base section 41. Unlike the first housing unit 3 described above, the second housing unit 4 does not include a cover member on an upper side of the base section 41, and the space at the upper side of the base section 41 is open.

Although the housing 2 has been described above, the housing 2 is not particularly limited. For example, the second housing unit 4 may be omitted depending on the configuration of the cell device 1. At least one housing unit may be further connected to the second housing unit 4 on a minus side in the X-axis direction. At least one housing unit may be further connected to the first housing unit 3 on a plus side in the X-axis direction. The second housing unit 4 may be provided with a cover member similar to that of the first housing unit 3 to define an accommodation space for accommodating the injection molding machine 6. The door 33 is not limited to an opening door, and may be, for example, a sliding door, a folding door, or the like.

### Injection Molding Machine 6

As shown in FIG. 1, the injection molding machine 6 is supported on the second housing unit 4. The injection molding machine 6 molds a molded article MD from a resin material. As shown in FIGS. 1 and 6, the injection molding machine 6 is a vertical injection molding machine, and includes a material storage section 61 for storing a resin material, a molding die 62 that is provided with an upper side molding die 621 and a lower side molding die 622 and that partitions a cavity according to the shape of the molded article MD, an injection unit 63 for melting the resin material stored in the material storage section 61 and for injecting the molten resin material into the molding die 62, and a movement mechanism 64 for moving the lower side molding die 622.

The injection unit 63 is fixed to the base section 41 of the second housing unit 4 via a plurality of pillars 65. The material storage section 61 is arranged on an upper side of the injection unit 63, and the upper side molding die 621 is arranged to the lower side of the injection unit 63. Further, the lower side molding die 622 is arranged to the lower side of the upper side molding die 621, and the molding die 62 is opened and closed by moving the lower side molding die 622 vertically (in the Z-axis direction) with respect to the upper side molding die 621. The lower side molding die 622 that has been moved to the lower side is moved forward and backward (Y-axis direction) by the movement mechanism 64. Hereinafter, a state in which the molding die 62 is open and the lower side molding die 622 is positioned directly below the upper side molding die 621 is also referred to as a first state, and a state (state shown in FIG. 6) in which the lower side molding die 622 is moved forward (a minus side in the Y-axis direction) from the first state is also referred to as a second state.

Such an injection molding machine 6 is driven as follows. First, the molding die 62 is closed. Next, a molten resin material is injected into the molding die 62 from the injection unit 63. Thus, a cavity of the molding die 62 is filled with the resin material. Then, the resin material in the cavity is cooled and cured to obtain the molded article MD. Next, the molding die 62 is opened to bring the lower side molding die 622 into the first state, and the lower side molding die 622 is moved forward by the movement mechanism 64 into the second state. Then, the molded article MD in the lower side molding die 622 is pushed upward by a pin (not shown) arranged in the lower side molding die 622, thereby releasing the molded article MD from the lower side molding die 622. The molded article MD thus released from the molding die is gripped by the robot 5 and transported to a predetermined position.

Although the injection molding machine 6 has been described above, the injection molding machine 6 is not particularly limited as long as it can mold the molded article MD.

### Robot 5

As shown in FIG. 2, the robot 5 is arranged in the first accommodation space S1 and is supported on the placement section 341 of the placement base 34. By supporting the robot 5 on the placement section 341, the placement base 34 functions as a spacer, allowing the robot 5 to be installed at a desired height with respect to the injection molding machine 6. That is, the placement base 34 is determined so that the robot 5 has a desired height with respect to the injection molding machine 6.

The robot 5 grips the molded article MD molded by the injection molding machine 6 and transports the molded article MD to a predetermined position. The robot 5 is a SCARA robot (horizontal articulated robot), and includes a base 50 fixed to the placement section 341, a first arm 51 that pivots around the Z-axis with respect to the base 50, a second arm 52 that pivots around the Z-axis with respect to the first arm 51, and a spline shaft 53 that is arranged at a tip end section of the second arm 52 and that extends in the Z-axis direction. The spline shaft 53 is rotatable around its central axis with respect to the second arm 52 and is movable up and down along the central axis. A hand 54 for gripping the molded article MD is attached to a lower end section of the spline shaft 53.

Although not particularly limited, the distance between the placement section 341 of the placement base 34 and the upper end of the first accommodation space S1, denoted as D1, and the height of the robot 5, denoted as D2, it is desirable that D1/D2 is 1.1 or more and 1.3 or less. With such dimensions, it is possible to suppress the overall height of the housing 2 to a low level while sufficiently securing a work area of the robot 5. By suppressing the overall height of the housing 2, the cell device 1 can be reduced in size, and maintainability can be improved.

The hand 54 is not particularly limited as long as it can grip the molded article MD, and in the present embodiment, the hand 54 is a parallel movement type air chuck driven using compressed air (hereinafter, also referred to as “air”) as a fluid. As shown in FIGS. 7 and 8, such a hand 54 includes an air cylinder 540 including a body 541 and a piston 542 that protrudes and retreats with respect to the body 541, a pair of claw sections 544a and 544b that open and close along a guide provided in the body 541, and a pair of levers 545a, 545b that are positioned between the piston 542 and the claw sections 544a and 544b and that transmit the movement of the piston 542 to the claw sections 544a and 544b. The body 541 is formed with a rod side air intake port 541a communicating with a space on a rod side of the piston 542, and a head side air intake port 541b communicating with a space on a head side of the piston 542.

The rod side air intake port 541a is connected to a solenoid valve 72 via a first air pipe 71a, and the head side air intake port 541b is connected to the solenoid valve 72 via a second air pipe 71b. Although not shown, the solenoid valve 72 is, for example, connected to a compressed air supply device such as a compressor installed in a factory or the like via a regulator. The solenoid valve 72 can switch air supply direction. As shown in FIG. 7, when air is supplied from the rod side air intake port 541a and discharged from the head side air intake port 541b, the piston 542 retreats into the body 541, the claw sections 544a and 544b close, and the molded article MD can be gripped. On the other hand, as shown in FIG. 8, when air is supplied from the head side air intake port 541b and discharged from the rod side air intake port 541a, the piston 542 protrudes from the body 541, the claw sections 544a and 544b open, and the molded article MD can be released.

A first speed controller 73a for adjusting the flow speed of air is arranged in the middle of the first air pipe 71a, and a second speed controller 73b for adjusting the flow speed of air is arranged in the middle of the second air pipe 71b. By adjusting the flow speed of air by the first speed controller 73a and the second speed controller 73b, it is possible to adjust the moving speed of the piston 542, that is, the opening and closing speed of the claw sections 544a and 544b.

As shown in FIGS. 4 and 5, the solenoid valve 72 includes a lever-type switch 721, which is a switching section for switching air supply direction. For example, in a case where the robot 5 is urgently stopped in a state of gripping the molded article MD, an operation of removing the molded article MD from the robot 5 is required for a recovery operation. In this case, by operating the switch 721 to reverse the flow of air in the hand 54 and open the claw sections 544a and 544b, the molded article MD can be easily removed. However, the configuration of the switching section is not particularly limited, and may be a button type, a slide type, a dial type, a touch panel type, or the like.

The first speed controller 73a includes a screw-type (dial-type) knob 731a as a fluid speed adjustment section for adjusting the flow speed of air flowing through the first air pipe 71a. As the screw-type knob 731a is tightened, a tip end section of the knob 731a protrudes into the first air pipe 71a and blocks the inside of the pipe, so that the flow speed of air is reduced accordingly. Similarly to the first speed controller 73a, the second speed controller 73b also includes a screw-type knob 731b as a fluid speed adjustment section for adjusting the flow speed of air flowing through the second air pipe 71b. However, the configuration of the fluid speed adjustment section is not particularly limited, and may be a lever type, a button type, a touch panel type, or the like.

Hereinafter, the switch 721 and the knobs 731a and 731b are collectively referred to as an “operation section 70”.

As shown in FIGS. 4 and 5, the operation section 70 is arranged on the placement base 34 in the first accommodation space S1. By arranging the operation section 70 on the placement base 34 in this manner, the operation section 70 can be arranged outside a work area of the robot 5, so that the possibility that the operation section 70 interferes with the robot 5 is reduced. The body of a user is unlikely to collide with the robot 5 during an operation of the operation section 70, the safety of the cell device 1 is improved, and the failure of the robot 5 can be suppressed. By arranging the operation section 70 outside the work area of the robot 5, it is also possible to secure work area for the robot 5 that is that much wider.

In particular, the operation section 70 is arranged on the front surface section 342a of the placement base 34. That is, the operation section 70 is arranged to face the door 33. According to such an arrangement, when the door 33 is opened, the operation section 70 appears on a front side, so that the operation section 70 can be easily operated. In particular, as described above, since the frame 331 is arranged so as to overlap the entire region of the side wall 342, the entire operation section 70 is hidden by the frame 331 wherever the operation section 70 is arranged within the front surface section 342a. Therefore, the design flexibility of the arrangement of the operation section 70 increases. Furthermore, the operation section 70 is arranged on a door 33 side rather than the robot 5, that is, on a front surface side. According to such an arrangement, it is possible to approach the operation section 70 without being obstructed by the robot 5, and it is easy to operate the operation section 70.

By thus arranging the operation section 70 on the front surface section 342a of the placement base 34, the operation section 70 can be hidden by the door 33 in the same manner as the interlock device 39 described above. Therefore, it is possible to reduce unnecessary information from entering the field of view of a user during normal operations. As a result, the user can perform work using the cell device 1 more intensively. Since the operation section 70 can be covered with the door 33, it is possible to effectively suppress an erroneous operation of the operation section 70 by a user during normal operations.

In particular, there is no opportunity to use the switch 721 and the knobs 731a and 731b included in the operation section 70 used except for inspection, adjustment, maintenance, recovery work from emergency stop, and the like. Specifically, the switch 721 is mainly used in a state where the door 33 is opened at the time of recovery from emergency stop of the robot 5. The knob 731a and 731b are mainly used in a state where the door 33 is opened at the time of adjustment of the robot 5 before an operation. Therefore, the switch 721 and the knobs 731a and 731b are used only in a state in which the door 33 is opened, and are not used in a state in which the door 33 is closed. Therefore, even if the switch 721 and the knobs 731a and 731b arranged in the first accommodation space S1 are covered by the door 33, opening and closing of the door 33 does not complicate operations of the operation section 70. Therefore, an erroneous operation of the operation section 70 can be suppressed without sacrificing usability.

In the present embodiment, the operation section 70 includes the switch 721 and the knobs 731a and 731b, however, the configuration of the operation section 70 is not particularly limited as long as it is not operated in a state where the door 33 is closed and is operated when the door 33 is open. For example, a main power button of the cell device 1 may also be included. The entire operation section 70 does not necessarily overlap the light blocking section, and at least a part of the operation section 70 may overlap and be hidden by the light blocking section to the extent that a user cannot visually recognize the operation section 70. The light blocking property of the light blocking section may be a light blocking property to the extent that a user cannot visually recognize the operation section 70.

### Control Device 9

As shown in FIG. 1, the control device 9 is arranged in the second accommodation space S2 of the first housing unit 3. The control device 9 controls the driving of the injection molding machine 6 and the robot 5 in conjunction with each other. The control device 9 is formed of, for example, a computer, and includes a processor (CPU) that processes information, a memory that is communicably connected to the processor, and an external interface that is connected to an external device. Various programs executable by the processor are stored in the memory, and the processor can read and execute the various programs and the like stored in the memory.

In particular, as shown in FIG. 3, the control device 9 is electrically connected to the robot 5 via the wiring L accommodated in the placement base 34. Therefore, by arranging the control device 9 below the placement base 34, it is easy to connect the wiring L and the control device 9. The length of the wiring L can be shortened.

Above, the cell device 1 has been described. As described above, the cell device 1 includes the housing 2 including the first accommodation space S1 as an accommodation space and the door 33 connected to the first accommodation space S1, the robot 5 as a movable device arranged in the first accommodation space S1, and the operation section 70 arranged in the first accommodation space S1 and configured to operate the robot 5. The door 33 includes the frame 331 as a light blocking section having a light blocking property, and the window section 332 as a light transmitting section having light transmissivity. In a state where the door 33 is closed, when the housing 2 is viewed from a door 33 side along a normal direction of the door 33, the frame 331 overlaps the operation section 70. According to such a configuration, during an operation of the cell device 1, the operation section 70 is hidden and does not enter a user's field of view. Therefore, it is possible to reduce unnecessary information that enters the field of view of a user. As a result, the user can perform work using the cell device 1 more intensively. Since the operation section 70 can be covered with the door 33, it is possible to effectively suppress erroneous operations of the operation section 70 by a user.

As described above, the operation section 70 is not operated in a state where the door 33 is closed, but is operated in a state where the door 33 is open. Thus, the operation section 70 is operated only when the door 33 is open, that is, by arranging the operation section 70, which has no opportunity to be operated, in the first accommodation space S1 and covering the operation section 70 with the door 33, the opening and closing of the door 33 do not complicate operations of the operation section 70. Therefore, an erroneous operation of the operation section 70 can be suppressed without sacrificing usability.

As described above, the operation section 70 is arranged in the first accommodation space S1 so as to face the door 33. According to such a configuration, when the door 33 is opened, the operation section 70 appears on a front side, and thus the operation section 70 is easily operated.

As described above, the operation section 70 is arranged on a door 33 side rather than the robot 5, that is, on a front surface side. According to such a configuration, it is easy to approach the operation section 70, and it is easy to operate the operation section 70.

As described above, the housing 2 includes the placement base 34 that is arranged in the first accommodation space S1 and on which the robot 5 is supported. The operation section 70 is arranged on the side wall 342 of the placement base 34. According to such a configuration, since the operation section 70 can be arranged outside a work area of the robot 5, the possibility that the operation section 70 interferes with the robot 5 is reduced. The body of a user is unlikely to collide with the robot 5 during an operation of the operation section 70, the safety of the cell device 1 is improved, and the failure of the robot 5 can be suppressed. By arranging the operation section 70 outside the work area of the robot 5, it is also possible to secure work area for the robot 5 that is that much wider.

Further, as described above, in a state where the door 33 is closed, the frame 331 overlaps the entire region of the side wall 342 when the housing 2 is viewed from a door 33 side along a normal direction of the door 33. Thus, even if the operation section 70 is arranged at any position of the side wall 342, since it is hidden by the frame 331, the design flexibility of the arrangement of the operation section 70 increases.

As described above, the operation section 70 includes the knobs 731a and 731b as fluid speed adjustment sections for adjusting the speed of compressed air, which is the fluid supplied to the robot 5. Such knobs 731a and 731b are used in a state where the door 33 is opened at the time of adjustment of the robot 5 before an operation, and are not used at the time of normal operations, that is, in a state where the door 33 is closed. Therefore, the knobs 731a and 731b are suitable as the operation section 70, and by covering the knobs 731a and 731b with the door 33, it is possible to suppress an erroneous operation of the knobs 731a and 731b.

As described above, the operation section 70 includes the switch 721 as a switching section that switches supply direction of compressed air supplied to the robot 5. Such a switch 721 is used in a state where the door 33 is opened at the time of recovery from emergency stop of the robot 5, and is not used at the time of normal operations, that is, in a state where the door 33 is closed. Therefore, the switch 721 is suitable as the operation section 70, and by covering the switch 721 with the door 33, it is possible to suppress an erroneous operation of the switch 721.

As described above, the cell device 1 includes the interlock device 39 that is arranged in the first accommodation space S1 and that restricts opening and closing of the door 33. In a state where the door 33 is closed, the frame 331 overlaps with the interlock device 39 when the housing 2 is viewed from a door 33 side along a normal direction of the door 33. According to such a configuration, during an operation of the cell device 1, the interlock device 39 is hidden and does not enter the field of view of a user. Therefore, it is possible to reduce unnecessary information that enters the field of view of a user. As a result, the user can perform work using the cell device 1 more intensively.

Although the cell device of the present disclosure has been described above based on the shown embodiment, the present disclosure is not limited thereto, and the configuration of each section can be replaced with an arbitrary configuration having the same function. Any other component may be added to the present disclosure.

1. A cell device comprising:
a housing including an accommodation space and a door connected to the accommodation space;
a movable device arranged in the accommodation space; and
an operation section arranged in the accommodation space and configured to operate the movable device, wherein
the door includes a light blocking section having a light blocking property and a light transmitting section having light transmissivity and
in a state where the door is closed, the light blocking section overlaps with the operation section when the housing is viewed from a door side along a normal direction of the door.

2. The cell device according to claim 1, wherein
the operation section is not operated when the door is closed and is operated when the door is open.

3. The cell device according to claim 1, wherein
the operation section is arranged in the accommodation space so as to face the door.

4. The cell device according to claim 3, wherein
the operation section is arranged further to the door side than is the movable device.

5. The cell device according to claim 1, wherein
the housing includes a placement base that is arranged in the accommodation space and on which the movable device is supported and
the operation section is arranged on a side wall of the placement base.

6. The cell device according to claim 5, wherein
in a state where the door is closed, the light blocking section overlaps with an entire region of the side wall when the housing is viewed from the door side.

7. The cell device according to claim 2, wherein
the operation section includes a fluid speed adjustment section for adjusting speed of a fluid supplied to the movable device.

8. The cell device according to claim 2, wherein
the operation section includes a switching section for switching supply direction of a fluid supplied to the movable device.

9. The cell device according to claim 1, further comprising:
an interlock device that is arranged in the accommodation space and that restricts opening and closing of the door, wherein
in a state where the door is closed, the light blocking section overlaps with the interlock device when the housing is viewed from the door side.
